(19) United States
(12) Patent Application Publication
(10) Pub. No.: US 2014/0146433 A1
(43) Pub. Date: May 29, 2014

(54) Three-Phase Circuit-Breaker

(71) Applicant: HITACHI, LTD., TOKYO (JP)

(72) Inventors: Hideaki UCHIYAMA, Tokyo (JP); Masanori TSUKUSHI, Tokyo (JP); Satoko KOYAMA, Tokyo (JP)

(73) Assignee: HITACHI, LTD., TOKYO (JP)

(21) Appl. No.: 14/085,341

(22) Filed: Nov. 20, 2013

(30) Foreign Application Priority Data
Nov. 29, 2012 (JP) 2012-260467

(51) Int. Cl. H01H 3/26

(52) U.S. Cl. CPC H01H 3/26
USPC 361/115

(57) ABSTRACT

A three-phase circuit-breaker includes: three circuit-breaking portion tanks that each have a circuit-breaking portion therein and are filled with insulating gas; an operation unit that opens and closes the circuit-breaking portion; and a driving mechanism that transmits driving force of the operation unit to the circuit-breaking portion. The operation unit is composed of a drive motor and a control power unit that outputs an opening/closing command to the drive motor. The drive motor is provided in the vicinity of the driving mechanism. The control power unit is disposed at a place different from the drive motor. The drive motor and the control power unit are electrically connected.

### BACKGROUND

The present invention relates to a three-phase circuit-breaker, and more particularly, to a three-phase circuit-breaker which includes an operation unit structure allowing miniaturization of a gas-insulated switchgear.

In recent power switching apparatuses, responding to the increase in power demand and the needs for miniaturization and high reliability of power equipment, there has been a remarkable tendency to mainly use a gas-insulated switchgear (hereinafter referred to as GIS), in which an electrical apparatus, such as a live conductor or a circuit-breaking portion, is stored within a tank filled with sulfur hexafluoride (SF₆) gas having high insulation and interruption performance, thereby significantly reducing the whole size of the switchgear.

The most important element of the GIS is a circuit-breaker (hereinafter referred to as GCB). The GCB has a structure in which a circuit-breaking portion is supported through an insulating spacer within the circuit-breaking portion tank filled with the SF₆ gas.

The circuit-breaking portion is driven at a high speed so as to quickly interrupt not only a load current at normal time, but also a short circuit large-current at a fault. The driving energy thereof is large, and, in the related art, a large-sized operation unit is mounted outside the circuit-breaking portion tank and driven by hydraulic pressure or spring force.

All the hydraulic pressure or spring force other than by a pump or motor is generated by the control or amplification action of mechanical system or high pressure fluid system. Therefore, the operation unit is increased in size and occupies a considerable portion (such as overall length, overall height, overall width, and hence an installation area and a volume) of the elements of the GCB.

In particular, the operation unit is mounted at an end or lower portion of the circuit breaking portion tank so as to fulfill its purpose, resulting in an increase in the overall length and overall height of the GCB. For overhaul or inspection of the circuit-breaking portion of the GCB, the operation unit must be mounted on a front surface of the GIS, and therefore the size of GCB has been necessarily the factor that determines the size of the GIS.

Japanese Unexamined Patent Application Publication No. Sho64(1989)-6340 discloses an electric spring-operated gas circuit-breaker, in which an output shaft connected to a circuit-breaking portion in a circuit-breaking portion tank is introduced into an operation unit box from a back plate side of the operation unit box and one end of each of an opening spring and a closing spring is connected to the output shaft. In the electric spring-operated gas circuit-breaker, the opening spring and the closing spring are arranged on an operation axis almost parallel to an operating direction of the output shaft and in a direction perpendicular to the back plate, and a fixed end of each of the opening spring and the closing spring is fixed to the back plate.

In this construction, because the operation unit is increased in size and length in order to cope with a large operating force and a long operating stroke, a spring case for storing the closing spring must be disposed so as to extend from the operation unit box to a lower portion of the circuit-breaking device. Therefore, it becomes necessary to raise the overall height of the GCB, and the reduction in the size and height of the GIS becomes difficult. Furthermore, there are the problems, such as an increase in the height of the center of gravity of the GIS as a whole and deterioration in earthquake resistance.

Japanese Unexamined Patent Application Publication No. Sho62 (1987)-249325 discloses a gas circuit-breaker for electric power, which includes: a metal tank filled with insulating gas; a circuit-breaking device stored in the metal tank; a pressure accumulator installed outside the metal tank; a drive unit for the circuit-breaking device disposed in an isolated manner from the pressure accumulator and driven by high pressure oil stored in the pressure accumulator; and a cover member that encloses the pressure accumulator to separate it from outside air.

In this construction, the pressure accumulator serving as a source to keep hydraulic pressure exists as a long object, and needs to be installed in the vicinity of an operation unit main body. Therefore, there is a problem of limitations on the degree of freedom in design.

Furthermore, in a hydraulic operation unit, although an operating cylinder body is small, it is necessary to use large and heavy components for bearing a high pressure oil of several hundred atmospheric pressures. This causes a problem of an increase in the size of the GCB.

### SUMMARY

Although reduction in the overall length, overall height, and overall width of the GCB is essential to reduce the size and height of the GIS, there is a limit on the miniaturization because the size of the circuit-breaking portion tank is determined according to a large fault current high-speed interrupting function which is the largest role of the GCB. Therefore, while miniaturization of the operation unit is desired, it currently has limitations.

That is because, since the operation unit requiring high speed and high output is composed mostly of the mechanical system or fluid system and the transmission efficiency and transmission speed of mechanical power or hydraulic power are considered to be important, all elements around the operation output shaft must be put into one place.

That is, the miniaturization of the operation unit main body can be achieved if the above-described driving spring or accumulator can be disposed at a position separated from the operation unit main body, such as an upper portion of the breaker tank or a portion of the GIS, however, it has been difficult because there are many problems, such as transmission efficiency of operating force.

Accordingly, in view of the foregoing, an object of the present invention is to provide a circuit-breaker that includes an operation unit having a high degree of freedom of arrangement, which is suitable for reducing the size and height of a GIS.

According to an aspect of the present invention, a three-phase circuit-breaker includes three circuit-breaking portion tanks that each have a circuit-breaking portion therein and are filled with insulating gas; an operation unit that opens and closes the circuit-breaking portion; and a driving mechanism that transmits driving force of the operation unit to the circuit-breaking portion. The operation unit is composed of a drive motor and a control power unit that outputs an opening/closing command to the drive motor. The drive motor is provided in the vicinity of the driving mechanism. The control power unit is disposed at a place different from the drive motor. The drive motor and the control power unit are electrically connected.

With the electric linear motor operation unit according to the aspect of the present invention, the flexibility in arrangement of the drive motor is increased, and the control energy source keeping portion and the driving portion, which need to be integrated with each other in the related art, can be separated from each other and disposed at respective optional positions, thereby allowing reduction in the length, height, and occupied floor area of the GCB. Thus, the GIS can be reduced in size and height.

### BRIEF DESCRIPTION OF THE DRAWINGS

FIG. 1 is a perspective view of a three-phase circuit-breaker according to an embodiment of the present invention;

FIG. 2 is a side view of the three-phase circuit-breaker according to the embodiment of the present invention, in which an internal structure of an operation mechanism 5 is visualized;

FIG. 3 is a top plan view of the three-phase circuit-breaker according to the embodiment of the present invention, in which the internal structure of the operation mechanism 5 is visualized;

FIG. 4 is a view of the three-phase circuit-breaker according to the embodiment of the present invention, as viewed from the operation mechanism side, in which the internal structure of the operation mechanism 5 is visualized;

FIG. 5 is an enlarged view of a rotating lever according the embodiment of the present invention;

FIG. 6 is a sectional view of an internal structure of the three-phase circuit-breaker according to the embodiment of the present invention, showing an electrode closed state;

FIG. 7 is a sectional view of an internal structure of the three-phase circuit-breaker according to the embodiment of the present invention, showing an electrode open state;

FIG. 8 is a schematic structural view of a mover of the three-phase circuit-breaker according to the embodiment of the present invention;

FIG. 9 is a schematic diagram of an electric actuator of the embodiment of the present invention, showing a cross-sectional structure;

FIG. 10 shows a cross-sectional structure of the electric actuator of FIG. 9, as viewed in a Z direction;

FIG. 11 is a perspective view of an electric actuator according to the embodiment of the present invention; and

FIG. 12 shows a cross-sectional structure of FIG. 11.

### DETAILED DESCRIPTION

Hereinafter, a three-phase circuit-breaker according to an embodiment of the present invention will be described with reference to the accompanying drawings.

### First Embodiment

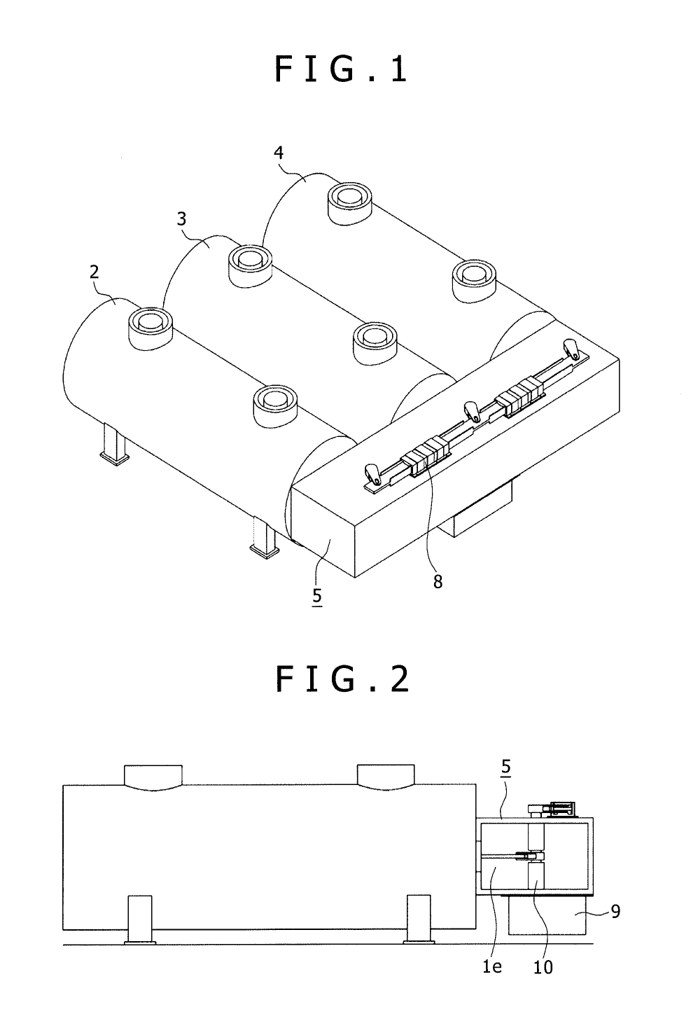

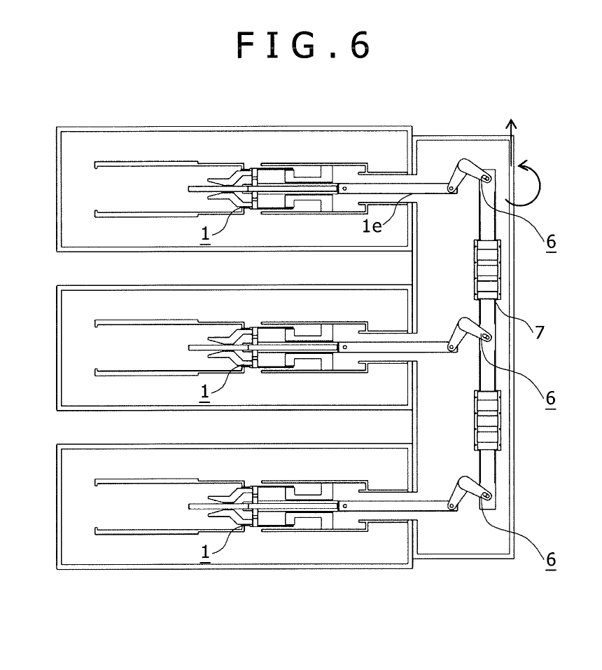

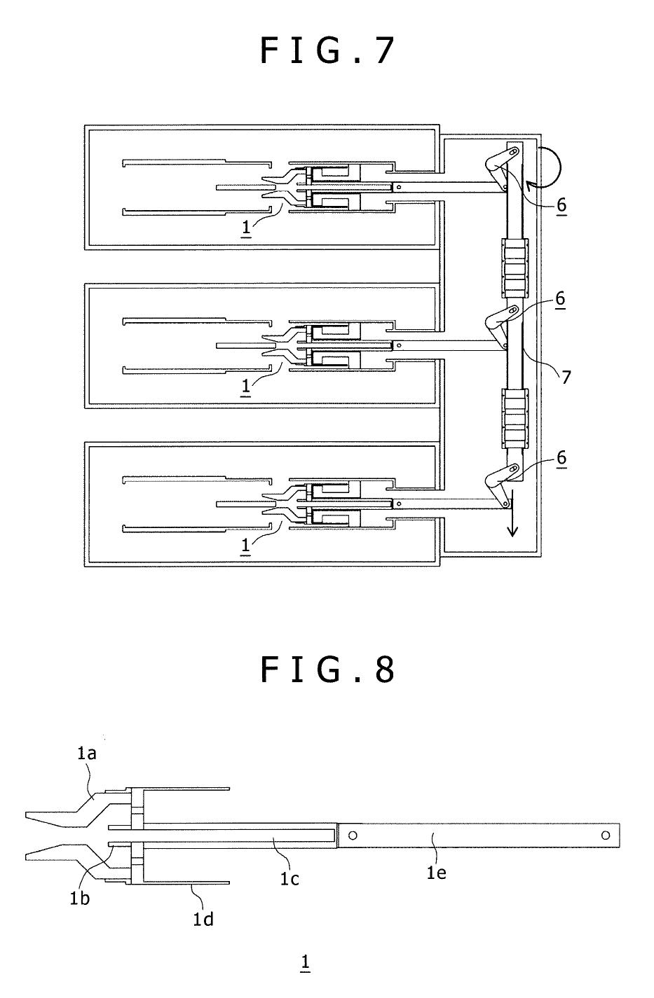

Within circuit-breaking portion tanks 2, 3, and 4 filled with SF₆ gas as shown in the perspective view of FIG. 1, respective circuit-breaking portions are disposed (see FIGS. 6 and 7).

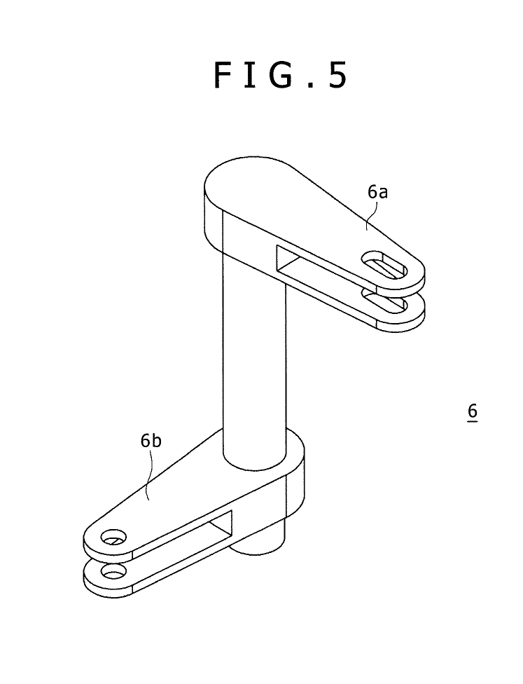

An operation mechanism 5 is disposed at an end of the tanks 2, 3, and 4. Rotating levers 6 are mounted on the operation mechanism 5 (see FIG. 5), with gas kept in an airtight state. Each of the rotating levers 6 is held by a bearing 10 (see FIGS. 2, and 4) and thereby pivots on the bearing 10. Furthermore, a gas seal portion is provided within the bearing 10 for keeping gas in an airtight state within the operation mechanism 5.

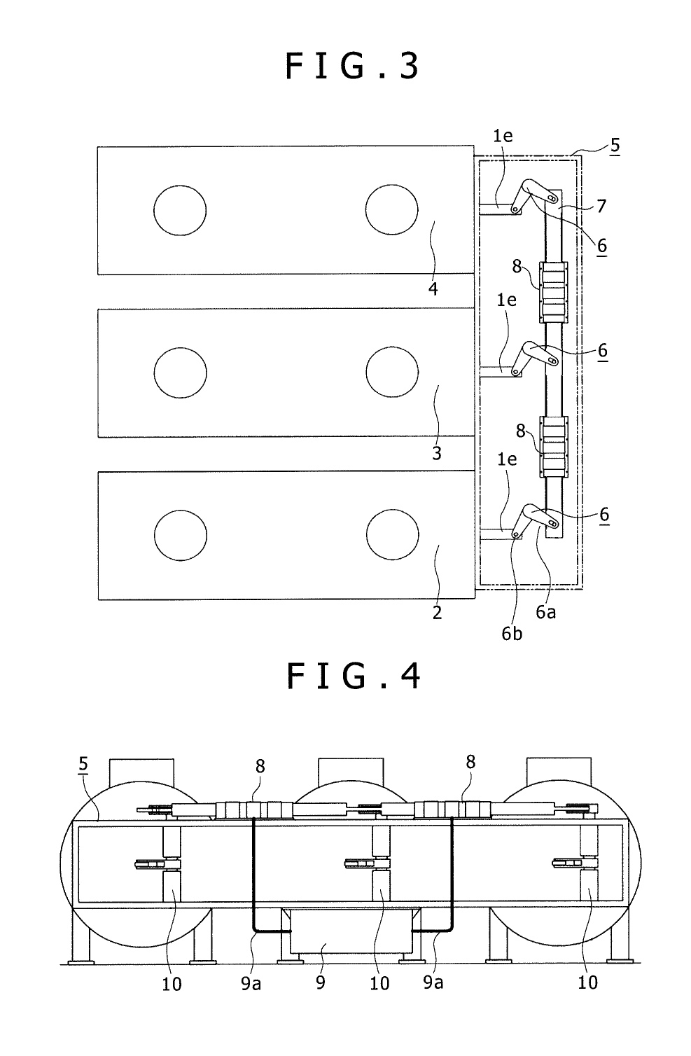

As shown in FIG. 5, according to this embodiment, the rotating lever 6 is composed of an in-air rotating lever 6a and an in-gas rotating lever 6b. The in-gas rotating lever 6b is structured to fasten an insulation operating rod 1e with a pin within the operation mechanism 5 (see FIG. 3). The insulation operating rod 1e transmits the driving force from the operation mechanism 5 to the circuit-breaking portion side.

The in-air rotating levers 6a for three phases, on an upper surface of the operation mechanism 5, are connected to a connecting rod 7 by pins (see FIG. 3). Since the connecting rod 7 moves linearly, each of the in-air rotating levers 6a has a long hole so that it is driven by the Scott-Russell mechanism.

A drive motor 8 of an electric linear motor operation unit according to this embodiment is sandwiched by the connecting rod 7 from both sides. In this embodiment, the drive motor 8 is fixed to an upper surface of the operation mechanism 5.

Although in FIG. 3, the two drive motors 8 are disposed among the phases, either of the two drive motors 8 is sufficient depending on required operating force.

A control power unit 9 that outputs an opening/closing command to the drive motors 8 can be connected to the drive motors 8 through cables 9a. Therefore, the control power unit 9, as the whole structure, takes little space and can be disposed at a convenient place. Although in FIG. 4, the control power unit 9 is disposed at a lower portion of the operation mechanism 5, but the location of the control power unit 9 is not limited thereto.

As shown in FIG. 6, if the three-phase circuit-breaker is in the ON position, the rotating lever 6 fastened to the connecting rod 7 is rotated in a counterclockwise direction through the bearing by the stroke of the connecting rod 7 in an upper direction in the figure. This causes the insulation operating rod 1e connected to the rotating lever 6 to move to the right side of the drawing sheet, thereby shifting the circuit-breaking portion 1 to the OFF position.

On the contrary, as shown in FIG. 7, if the circuit-breaker is in the OFF position, the circuit-breaking portion 1 is shifted to the ON position by the stroke of the connecting rod 7 in a lower direction in the figure.

As shown in FIG. 8, the circuit-breaking portion 1 shown in FIGS. 6 and 7, on a movable side, is composed of at least an insulating nozzle 1a, a movable side arcing contact 1b serving as a contact portion for interrupting a current, a puffer shaft 1c, a puffer cylinder 1d, and an insulating operation rod 1e which are coaxially arranged.

The drive motors 8 are fixed to the upper surface of the operation mechanism 5 and electrically connected to the control power unit 9 fixed to a lower portion of the operation mechanism 5 (see FIG. 4).

A current value detected by a current-detecting transformer (not shown) for measuring a current of a main circuit conductor connected to a fixed side and a movable side of the circuit-breaking portion is inputted to the control power unit 9. The control power unit 9 has the function of changing the amount or phase of current to be supplied to the drive motors 8 according to the current value detected by the transformer.

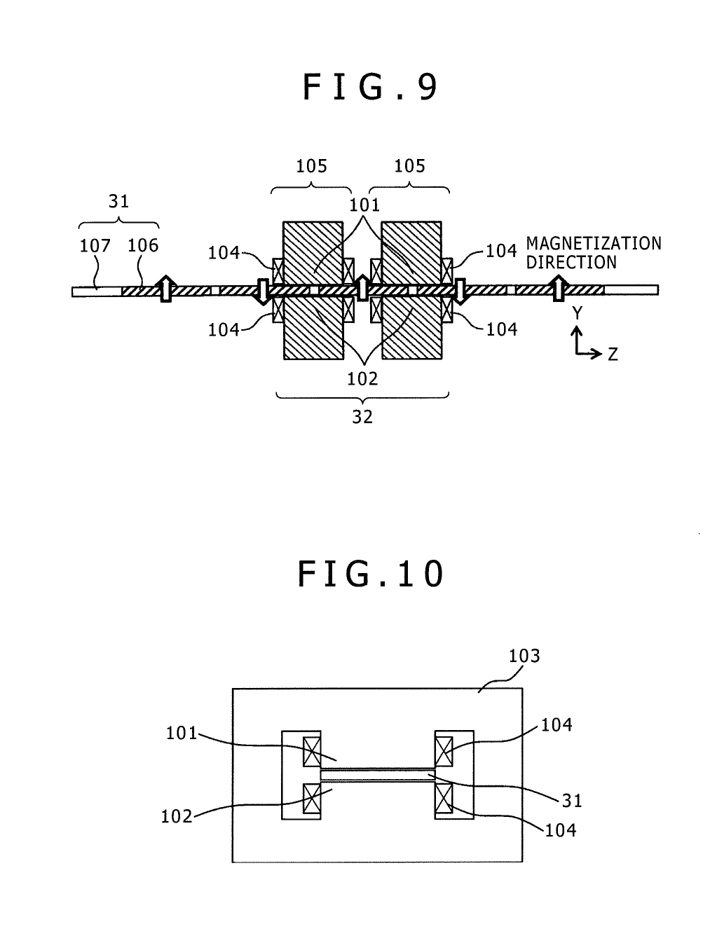

Hereinafter, a detailed structure of the drive motor 8 will be described with reference to FIGS. 9 and 10. FIG. 9 shows an electric actuator 32 and a mover 31 constituting the drive motor 8 according to this embodiment, and FIG. 10 shows a cross-sectional shape of a stator 105 shown in FIG. 9, as viewed in a Z direction.

In this embodiment, the electric actuator 32 includes the two stators 105 as one unit. As shown in FIG. 10, each of the stators 105 is composed of: a magnetic body 103; a first magnetic pole 101 included in the magnetic body 103; a second magnetic pole 102 opposed to the first magnetic pole 101; and a winding 104 provided at an outer periphery of each of the first and second magnetic poles 101 and 102.

The mover 31 is disposed between the first and second magnetic poles 101 and 102 of the stator 105 through a gap. The mover 31 is composed of permanent magnets 106 and magnet fixing members 107 for supporting the permanent magnets 106 while holding the permanent magnets 106 therebetween.

The permanent magnets 106 are magnetized in a Y direction (vertical direction in FIG. 9), and magnetized alternately for every adjacent magnets. Furthermore, the magnet fixing members 107 are made of a non-magnetic material.

The mover 31 is supported by a mechanical component that restrains the mover 31 against movement in directions other than the Z direction to keep a spacing between the permanent magnets 106 and each of the first and second magnetic poles 101 and 102.

At the time of driving, a magnetic field is generated by applying a current to the winding 104, and thrust corresponding to a relative position between the stators 105 and the permanent magnets 106 can be generated. Furthermore, the size and direction of thrust can be adjusted by controlling the positional relationship between the stators 105 and the permanent magnets 106 and the phase and magnitude of a current to be applied to the winding 104.

The electric linear motor operation unit, which is composed of the drive motor 8 having the above-described electric actuator 32, and the control power unit 9, generates operating force by conducting a current and thereby allows the movable electrode to stop at a total of three or more positions of an intermediate position of the stroke in addition to forward and rearward end positions of the stroke without requiring a complicated machine mechanism.

It should be noted that the above description is strictly for illustrative purposes, and an electric actuator having other configurations may be used, as long as it has a configuration which converts an electrical signal into driving force, thereby allowing the control of the magnitude and direction of the driving force and allowing the mover to stop and re-drive at a total of three or more positions, forward and rearward end positions of the stroke and an intermediate position of the stroke.

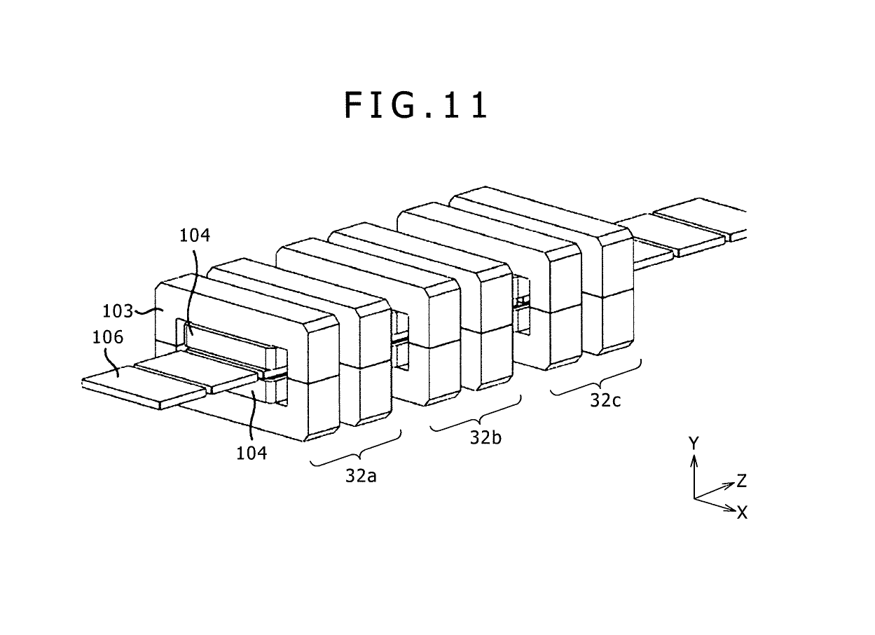

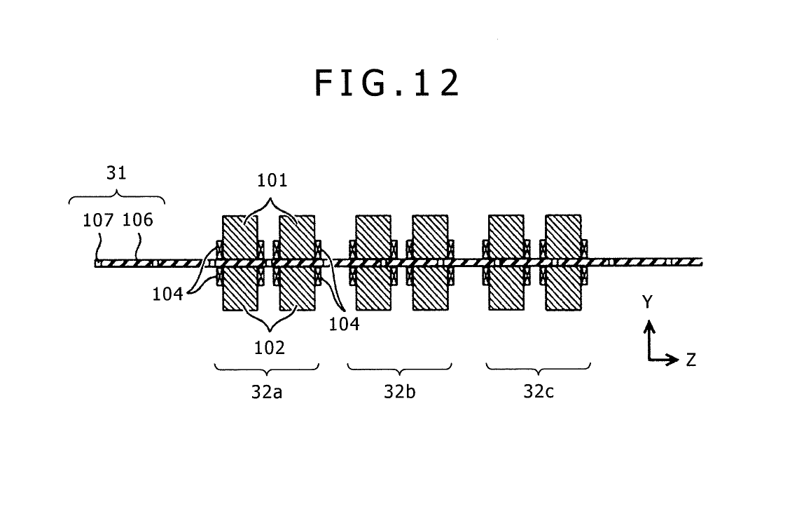

The drive motor 8 according to this embodiment will be described with reference to FIGS. 11 and 12. In this embodiment, three units of actuators 32a, 32b, and 32c are arranged in the Z direction (direction of the motion axis of the movable electrode).

It should be noted that although in this embodiment, as described above, one unit is composed of the two stators and the three units of electric actuators 32a, 32b, and 32c are composed of the six stators in total, the arrangement may be such that one unit is composed of one or more stators and the three units of electric actuators are composed of the stators whose number is three times as many as the one or more stators constituting one unit.

The electric actuator 32b and the electric actuator 32c are shifted in electric phase by 120° and 240°, respectively, with respect to the electric actuator 32a.

With this actuator arrangement, the same operation as a three-phase linear motor can be achieved by applying three phase currents to the windings 104 of the electric actuators 32a, 32b, and 32c. Using the three units of electric actuators 32a, 32b, and 32c allows thrust adjustment by individual current control of each of the actuators 32a, 32b, and 32c, as three independent electric actuators.

Currents having different sizes or phases can be injected into the respective windings of the electric actuators 32a, 32b, and 32c from the control power unit 9. As an example, there is a case where three phase currents U, V, and W from a single AC current are separately supplied. In this case, the need for a plurality of power sources is eliminated, and the configuration is facilitated.

As described above, with the electric linear motor operation unit according to the embodiment of the present invention, the flexibility in arrangement of the drive motor can be increased, and the control power unit and the drive motor, which need to be integrated with each other in the related art, can be separated from each other and disposed at respective optional positions, thereby allowing a reduction in the overall length, height, and occupied floor area of the GCB. Thus, the GIS can be reduced in size and height.

What is claimed is:

1. A three-phase circuit-breaker comprising:
three circuit-breaking portion tanks that each have a circuit-breaking portion therein and are filled with insulating gas;
an operation unit that opens and closes the circuit-breaking portion; and
a driving mechanism that transmits driving force of the operation unit to the circuit-breaking portion,
wherein the operation unit is composed of a drive motor and a control power unit that outputs an opening/closing command to the drive motor, the drive motor being provided in the vicinity of the driving mechanism, the control power unit being disposed at a place different from the drive motor, the drive motor and the control power unit being electrically connected.

2. The three-phase circuit-breaker according to claim 1, wherein the driving mechanism has a rotating lever serving as Scott-Russell mechanism, the rotating lever having two ends, one end of the rotating lever being connected to a connecting rod that transmits driving force from the drive motor, the other end of the rotating lever being connected to an insulation operating rod that transmits the driving force from the drive motor to the circuit-breaking portion.

3. The three-phase circuit-breaker according to claim 2, wherein the drive motor is disposed at an upper surface of the driving mechanism, and the control power unit is disposed at a lower surface of the driving mechanism.

4. The three-phase circuit-breaker according to claim 1,
wherein the drive motor includes:
a mover composed of a plurality of integrally-formed permanent magnets or magnetic materials arranged with magnetization directions alternately inverted; and
a stator composed of: first and second magnetic poles arranged to hold the mover from upper and lower sides; a magnetic body connecting the first and second magnetic poles to form a magnetic flux path; and a winding wound around each of the first and second magnetic poles, and
wherein the control power unit changes an amount of current to be supplied to the winding according to a value of a current flowing through the main circuit conductor, the current value being detected by a current detector.

5. The three-phase circuit-breaker according to claim 2,
wherein the drive motor includes:
a mover composed of a plurality of integrally-formed permanent magnets or magnetic materials arranged with magnetization directions alternately inverted; and
a stator composed of: first and second magnetic poles arranged to hold the mover from upper and lower sides; a magnetic body connecting the first and second magnetic poles to form a magnetic flux path; and a winding wound around each of the first and second magnetic poles, and
wherein the control power unit changes an amount of current to be supplied to the winding according to a value of a current flowing through the main circuit conductor, the current value being detected by a current detector.

6. The three-phase circuit-breaker according to claim 3,
wherein the drive motor includes:
a mover composed of a plurality of integrally-formed permanent magnets or magnetic materials arranged with magnetization directions alternately inverted; and
a stator composed of: first and second magnetic poles arranged to hold the mover from upper and lower sides; a magnetic body connecting the first and second magnetic poles to form a magnetic flux path; and a winding wound around each of the first and second magnetic poles, and
wherein the control power unit changes an amount of current to be supplied to the winding according to a value of a current flowing through the main circuit conductor, the current value being detected by a current detector.

7. The three-phase circuit-breaker according to claim 4,
wherein the stators whose number is equal to integer three times the number of the stators constituting one unit are disposed in a moving direction of the mover, and
wherein the winding is shifted in electric phase by 120° for every adjacent unit of the stators, and operation as a three-phase linear motor is achieved by applying three phase currents to the windings of the units of the stators.

8. The three-phase circuit-breaker according to claim 5,
wherein the stators whose number is equal to integer three times the number of the stators constituting one unit are disposed in a moving direction of the mover, and
wherein the winding is shifted in electric phase by 120° for every adjacent unit of the stators, and operation as a three-phase linear motor is achieved by applying three phase currents to the windings of the units of the stators.

9. The three-phase circuit-breaker according to claim 6,
wherein the stators whose number is equal to integer three times the number of the stators constituting one unit are disposed in a moving direction of the mover, and
wherein the winding is shifted in electric phase by 120° for every adjacent unit of the stators; and operation as a three-phase linear motor is achieved by applying three phase currents to the windings of the units of the stators.
